(19) United States
(12) Patent Application Publication
(10) Pub. No.: US 2015/0073893 A1
(43) Pub. Date: Mar. 12, 2015

(54) SYSTEMS AND METHODS OF TRACKING CONVERSIONS BY LOCATION

(71) Applicant: Tune, Inc., Seattle, WA (US)

(72) Inventor: Lee Brown, Seattle, WA (US)

(21) Appl. No.: 14/480,527

(22) Filed: Sep. 8, 2014

Related U.S. Application Data
(60) Provisional application No. 61/874,938, filed on Sep. 6, 2013.

(51) Int. Cl. G06Q 30/02

(52) U.S. Cl. CPC G06Q 30/0246
USPC 705/14.45

(57) ABSTRACT

Systems and methods for generating advertising conversions based on a physical location of an end user computing device are provided. An advertisement is presented using an end user computing device, and an ad impression record is generated. The location of the end user computing device is then monitored and compared to a geofence associated with the advertisement. The location may be monitored by the end user computing device itself or by a tracking system. Once the geofence area is entered and any other conditions associated with the geofence are satisfied, an ad conversion record is generated.

### CROSS-REFERENCE TO RELATED APPLICATION

This application claims the benefit of U.S. Provisional Application No. 61/874,938, filed Sep. 6, 2013, the entire disclosure of which is hereby incorporated by reference herein for all purposes.

### BACKGROUND

Many advertisers publicize products and/or services that are available at physical locations using online and/or mobile advertising. For example, a department store may create an online ad campaign for sale prices that are available in-store only. However, advertisers also wish to be able to connect the loop between the presentation of an advertisement to a potential customer and the eventual acquisition of that customer. Online advertising impressions can be connected to online purchases of the advertised product or service when the same computing device is used to present the advertisement to the user and to purchase the advertised product or service. However, when the product or service being advertised in an online advertisement is made available at a physical location, this type of conversion tracking is not available. What is desired are systems and methods that allow conversions to be generated when an end user visits a physical location in response to being presented an online or mobile advertisement.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method for determining advertising effectiveness is provided. An end user computing device generates an impression for an advertisement presented to an end user. The end user computing device monitors a location of the end user computing device, and generates a conversion for the advertisement in response to determining that a geofence condition associated with the advertisement has been satisfied based on the monitored location of the end user computing device.

In some embodiments, a system for determining advertising effectiveness is provided. The system comprises a tracking data store and a tracking engine. The tracking data store is configured to store a set of advertising impression records and a set of advertising conversion records. The tracking engine is configured to create an advertising impression record in the tracking data store in response to receiving an impression notification that indicates that an advertisement was presented to an end user; and to create an advertising conversion record in the tracking data store in response to receiving a conversion notification that indicates that a location of an end user computing device associated with the end user satisfied a geofence condition associated with the advertisement.

In some embodiments, a nontransitory computer-readable medium having computer-executable instructions stored thereon is provided. The instructions, in response to execution by one or more processors of an end user computing device, cause the end user computing device to perform actions for determining advertising effectiveness. The actions comprise generating, by the end user computing device, an impression for an advertisement presented to an end user; monitoring, by the end user computing device, a location of the end user computing device; and generating, by the end user computing device, a conversion for the advertisement in response to determining that a geofence condition associated with the advertisement has been satisfied based on the monitored location of the end user computing device.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic diagram that illustrates an exemplary embodiment of a tracking ecosystem according to various aspects of the present disclosure;

FIG. 2 is a block diagram that illustrates details of an exemplary embodiment of an end user computing device, an advertisement providing computing device, a customer computing device, and a tracking system according to various aspects of the present disclosure;

FIGS. 3A-3B are a flowchart that illustrates an exemplary embodiment of a method of detecting ad conversions based on user location information according to various aspects of the present disclosure

FIG. 4 illustrates an exemplary embodiment of a tracking link page generated by the management interface engine according to various aspects of the present disclosure;

FIG. 5 is a flowchart that illustrates an exemplary embodiment of a procedure for using a tracking system to monitor a location of an end user computing device according to various aspects of the present disclosure;

FIG. 6 is a flowchart that illustrates an exemplary embodiment of a procedure for monitoring a location of an end user computing device by the device itself, according to various aspects of the present disclosure;

FIG. 7 is a flowchart that illustrates another exemplary embodiment of a procedure for monitoring a location of an end user computing device by the device itself, according to various aspects of the present disclosure;

FIG. 8 is an illustration of an exemplary reports page generated by the management interface engine that may be used to analyze advertising performance and to display credits provided to attributed ad providers according to various aspects of the present disclosure; and

FIG. 9 is a diagram of hardware and an operating environment in conjunction with which implementations of the one or more computing devices of the ecosystem may be practiced.

### DETAILED DESCRIPTION

### Tracking System Overview

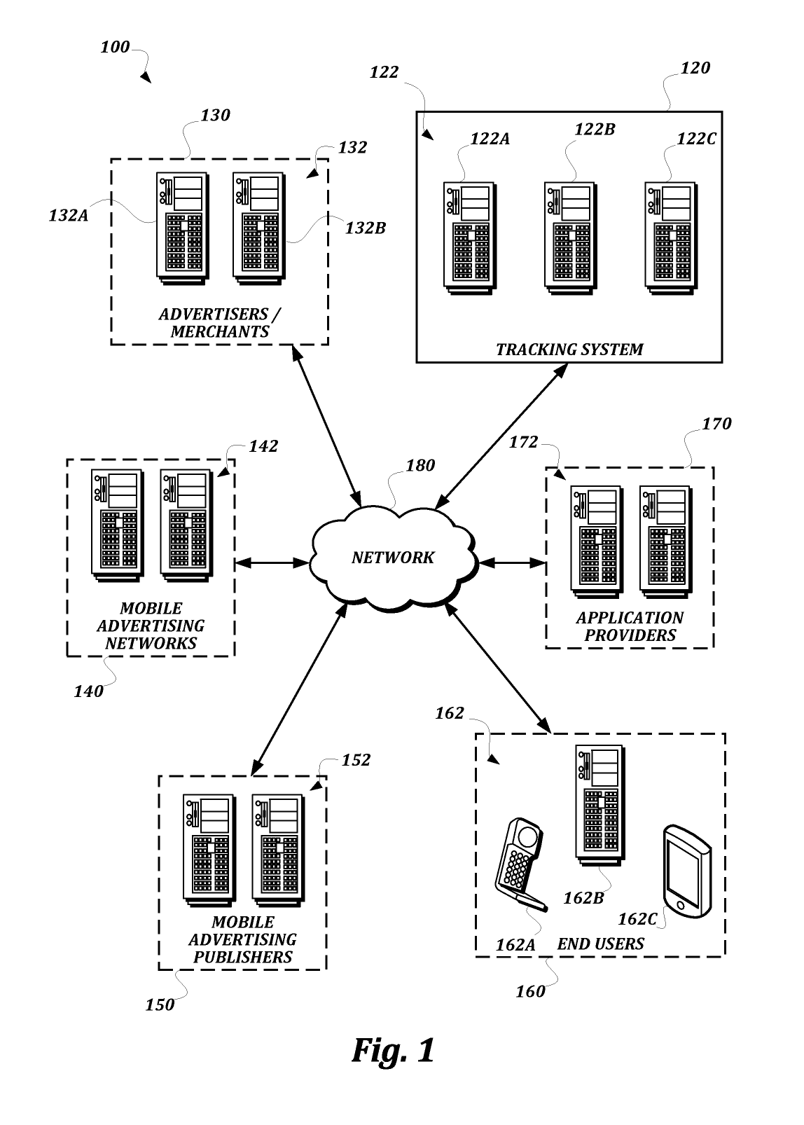

FIG. 1 is a schematic diagram that illustrates an exemplary embodiment of a tracking ecosystem 100 according to various aspects of the present disclosure. The tracking ecosystem 100 may be configured to match advertisement impressions with a subsequent visit to a location associated with the presented advertisements. This matching may allow ad conversions to be recorded and attributed to the appropriate party or parties that provided (e.g., distributed and/or displayed) the selected advertisements.

As illustrated, the system 100 includes a tracking system 120. The tracking system 120 includes one or more computing devices 122. In the embodiment illustrated, the computing devices 122 include a tracking server 122A, a storage service server 122B, and a management interface server 122C. In alternate embodiments, the computing devices 122 may include multiple tracking servers, multiple storage service servers, and/or multiple management interface servers. In some embodiments, the storage service server 122B is external to (and optionally remote from) the tracking system 120. In other embodiments, the functionality of the tracking server 122A and the storage service server 122B may be combined on a single computing device (not shown). In some embodiments, the functionality of the tracking server 122A and the management interface server 122C may be combined on a single computing device (not shown). The tracking system 120 is not limited to the use of a particular number of computing devices to implement the functionality of the tracking server 122A, the storage service server 122B, and the management interface server 122C.

The system 100 also includes one or more computing devices 132 operated by one or more Advertisers/Merchants 130, one or more computing devices 142 operated by one or more Mobile Advertising Networks 140, one or more computing devices 152 operated by one or more Mobile Advertising Publishers 150, a plurality of computing devices 162 operated by a plurality of End Users 160, and one or more computing devices 172 operated by one or more Application Providers 170.

As is apparent to those of ordinary skill in the art, in some embodiments, a single entity may function as one of the Advertisers/Merchants 130, one of the Mobile Advertising Networks 140, and one of the Mobile Advertising Publishers 150, even though they are illustrated in FIG. 1 as separate entities. Such an entity may operate one or more computing devices (not shown) that perform the functions of the computing devices 132, 142, and 152.

The Advertisers/Merchants 130 include companies that wish to advertise products and/or services. In some embodiments, the products and/or services may be available at one or more brick-and-mortar locations. For example, an advertiser/merchant 130 may include a proprietor of a retail store attempting to increase foot traffic to their store.

The Mobile Advertising Networks 140 include companies that help distribute advertisements for the Advertisers/Merchants 130 for presentation to end users. The Mobile Advertising Networks 140 may provide services to Mobile Advertising Publishers 150 that allow Mobile Advertising Publishers 150 to present advertisements received from the Mobile Advertising Networks 140 to end users. Non-limiting examples of such companies include Google (the AdWords platform), Apple (the iAd platform), Millennial Media, Tapjoy, InMobi, Advertising.com, AdColony, Jumptap, Nexage, and the like.

The Mobile Advertising Publishers 150 include providers of web sites and mobile applications that display advertisements. Non-limiting examples of such companies include Pandora, Spotify, Facebook, Twitter, Bittorrent.com, The Weather Channel, and any other application or website provider that displays advertisements. In some embodiments, a company may act as both a Mobile Advertising Network 140 and a Mobile Advertising Publisher 150.

The End Users 160 include people who use the computing devices 162 and view advertisements, such as those created by the Advertisers/Merchants 130, distributed by the Mobile Advertising Networks 140, and/or displayed by the Mobile Advertising Publishers 150. The End Users 160 may also use the computing devices 162 to purchase, download, install, and/or interact with applications provided by the Application Providers 170.

The Application Providers 170 include companies that provide installable applications to the End Users 160. Non-limiting examples of such companies include “app stores,” such as iTunes App Store, Google Play, Amazon Appstore, and the like. The one or more computing devices 172 may be configured to generate a download page (not shown) from which an application may be purchased, downloaded, and/or installed. The download page may be implemented as a webpage. The installable applications may include advertising functionality configured to present advertisements to the end user and to report tracking information to be consumed by the tracking system 120.

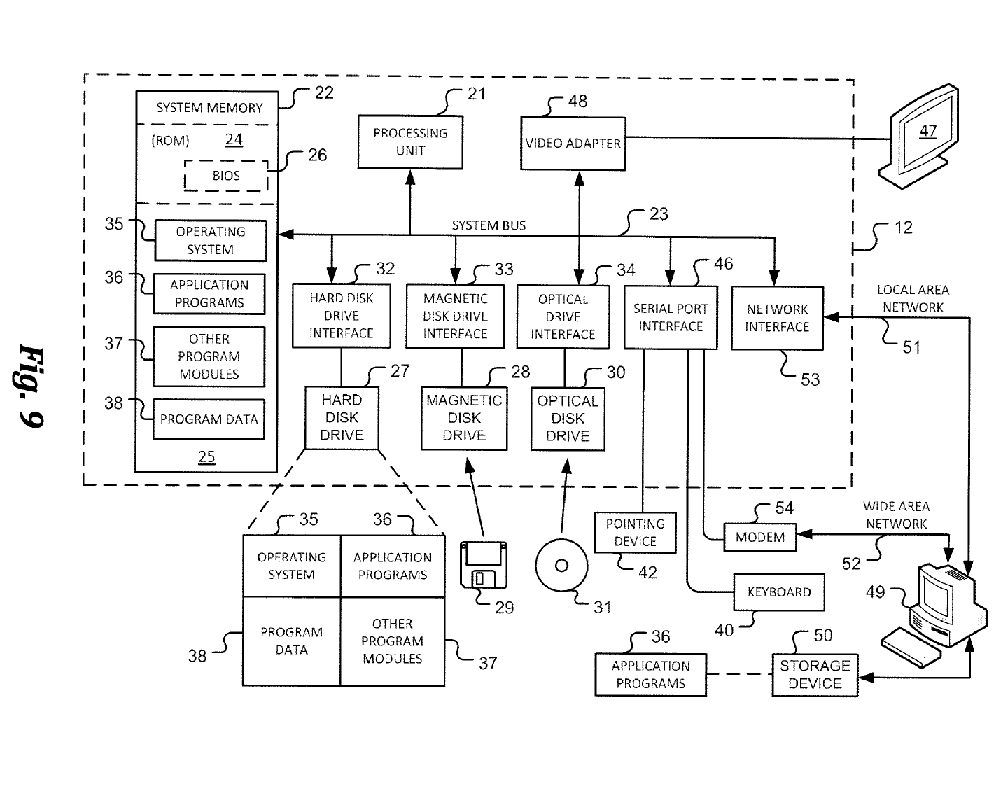

The computing devices 122, 132, 142, 152, 162, and 172 are connected to one another by a network 180 (e.g., the Internet). Each of the computing devices 122, 132, 142, 152, 162, and 172 may be implemented using a computing device similar to the computing device 12 illustrated in FIG. 9 and described below. By way of non-limiting examples, the computing devices 162 have been illustrated as including a cellular telephone 162A, a personal computer 162B (e.g., a desktop computer), and a tablet computer 162C. Each of the computing devices 162 may be configured to implement an advertisement displaying application.

### Tracking Advertising Impressions and Measuring Conversions Based on Location Information

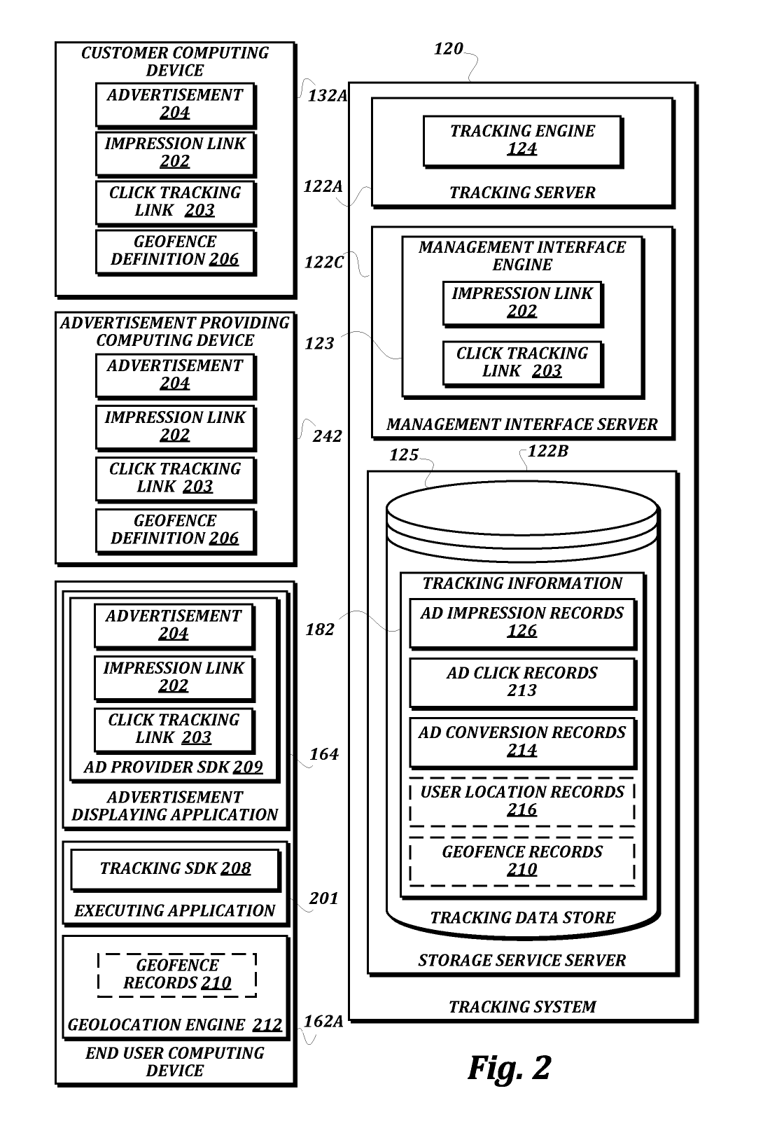

FIG. 2 is a block diagram that illustrates details of an exemplary embodiment of an end user computing device 162A, an advertisement providing computing device 242, a customer computing device 132A, and a tracking system 120 according to various aspects of the present disclosure.

The tracking server 122A is configured to provide a tracking engine 124 that communicates with the storage service server 122B. In general, the term “engine” as used herein refers to logic embodied in hardware or software instructions, which can be written in a programming language, such as C, C++, Objective-C, COBOL, JAVA™, PHP, Perl, HTML, CSS, JavaScript, Ruby, VBScript, ASPX, Microsoft .NET™ languages such as C#, and/or the like. An engine may be compiled into executable programs or written in interpreted programming languages. Software engines may be callable from other engines or from themselves. Generally, the engines described herein refer to logical modules that can be merged with other engines or applications, or can be divided into sub-engines. The engines can be stored in any type of computer-readable medium or computer storage device and be stored on and executed by one or more general purpose computers, thus creating a special purpose computer configured to provide the engine.

The storage service server 122B is configured to provide a tracking data store 125 that stores click tracking, impression, conversion, and/or location information received from the tracking server 122A and/or the management interface server 122C. As understood by one of ordinary skill in the art, a “data store” as described herein may be any suitable device configured to store data for access by a computing device. One example of a data store is a highly reliable, high-speed relational database management system (DBMS) executing on one or more computing devices and accessible over a high-speed network. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, as described further below. One of ordinary skill in the art will recognize that separate data stores described herein may be combined into a single data store, and/or a single data store described herein may be separated into multiple data stores, without departing from the scope of the present disclosure.

In some embodiments, the tracking data store 125 is configured to store tracking information 182 that includes one or more of a set of ad impression records 126, a set of ad click records 213, a set of ad conversion records 214, an optional set of user location records 216, and an optional set of geofence records 210. The set of user location records 216 and the set of geofence records 210 are optional because in some embodiments, a location of the end user computing device 162A is not monitored by the tracking system 120, but is instead monitored locally on the end user computing device 162A.

Each of the ad impression records 126 represents an occurrence of a given advertisement being presented to an end user. Each of the ad click records 213 represents an occurrence of a click (or other tracked interaction) associated with the presented advertisement. Each of the ad conversion records 214 represents an occurrence of an end user taking an action that was meant to be encouraged by an associated advertisement. In one example, an advertisement for a sale at a department store may be presented to the user. The user may then go to the department store to shop. In this example, an ad impression record 126 would be created upon the advertisement being presented to the user, and an ad conversion record 214 would be created upon the user visiting the department store.

In some embodiments, the tracking data store 125 is configured to store a set of user location records 216 and/or a set of geofence records 210. These records are each optional because in some embodiments, the tracking system 120 does not provide the functionality that uses these records. Each of the user location records 216 represents a location of an end user computing device 162A at a given time. Each of the set of geofence records 210 represents a geographical area related to an ad conversion. That is, if the end user computing device 162A is determined to have entered the geographical area defined by the geofence record 210 and any other conditions associated with the geofence record 210 are satisfied, an ad conversion is generated.

In some embodiments, the ad impression records 126, the ad conversion records 214, the user location records 216, and the geofence records 210 may be linked to a given end user computing device 162 by device identifying information. The device identifying information may include one or more device identifiers that may be assigned to the computing devices 162 to uniquely identify the computing devices 162, and may be used by the tracking system 122 to uniquely identify the end user computing device 162A or the user thereof.

Examples of device identifiers include, but are not limited to, a media access control (“MAC”) Address, an International Mobile Station Equipment Identity (“IMEI”), a Mobile Equipment Identifier (“MEID”), an Identifier for Advertising (“IFA”), an Identifier for Vendor (“IFV”), an Android ID, an Open Device Identification Number (“ODIN”), an Open Unique Device Identifier (“Open UDID”), a Google AdID, combinations thereof, and the like. By way of a non-limiting example, the IMEI may be an Android IMEI. By way of another non-limiting example, the MEID may be an Android MEID.

Other information associated with one of the computing devices 162 may also be used as device identifying information, and may include an Internet Protocol (“IP”) Address, browser information (e.g., browser type, browser version, a cookie, etc.), combinations thereof, and the like. This other information may be usable to identify a computing device 162, though the other information may be less reliable for uniquely identifying a computing device 162 than the device identifiers. Optionally, all or a portion of the device identifying information may be hashed before being used by the tracking system 120 as an identifier or to associate records in the tracking data store 125 with the end user computing device 162A.

An example system wherein user click records stored in a tracking data store 125 may be used to attribute actions to one or more advertising publishers 150 and provide credit to the attributed publishers may be found in commonly owned, co-pending U.S. patent application Ser. No. 14/304757, filed Jun. 13, 2014, the entire disclosure of which is hereby incorporated by reference for all purposes. One of ordinary skill in the art will recognize that similar techniques may be used to attribute ad impressions and/or ad conversions to one or more advertising publishers 150 that provided ad impressions 126.

The management interface server 122C includes a management interface engine 123 configured to generate a management interface, described below. One aspect of the management interface engine 123 is configured to access (e.g., via an Application Programming Interface (“API”) or other suitable technique) the information stored in the tracking data store 125 and use the information to generate displays (e.g., graphs, charts, lists, reports, etc.) for the management interface. Another aspect of the management interface engine 123 is configured to generate a management interface that allows customers to create links that may be used to track advertisement performance, as illustrated and described further below.

The management interface engine 123 may include or communicate with web server components (not shown) configured to present conventional webpages displayable by conventional Internet browser applications executing on computing devices, such as a computing device 12 illustrated in FIG. 9 and described below. The management interface presented by the management interface engine 123 may include one or more web pages that may be transmitted by the web server components (not shown) to other computing devices in the ecosystem 100. Such web pages may be displayed by conventional Internet browser applications executing on the recipient computing devices.

As illustrated, the end user computing device 162A includes an advertisement displaying application 164, an executing application 201, and a geolocation engine 212. The executing application 201 includes a tracking Software Development Kit (SDK) 208 and the advertisement displaying application 164 includes an ad provider SDK 209. The tracking SDK 208 is provided to the developer of the executing application 201 by the tracking system 120 and includes functions and/or procedures that execute when called from within the executing application 201 and may be used to report tracked activity on the end user computing device 162A to the tracking system 120. For example, the tracking SDK 216 may include computer-executable instructions that execute after an advertisement is presented by the end user computing device 162A. Likewise, the ad provider SDK 209 is provided to the developer of the advertisement displaying application 164 by the advertisement provider and includes functions and/or procedures that execute when called from within the advertisement displaying application 164 to perform tasks such as retrieving an advertisement from the advertisement providing computing device 242. In some embodiments, the advertisement displaying application 164 and the executing application 201 may not be separate, but may instead be the same application.

By way of a non-limiting example, the tracking SDK 208 and/or the ad provider SDK 209 may be implemented as a library file that is included in an application project used to create the associated application. For the tracking SDK 208, an application developer may specify which particular functions are called from the library, and when, to indicate to the tracking engine 124 when ad impressions, ad conversions, and/or other events have occurred. Likewise, for the ad provider SDK 209, an application developer may specify which particular functions are called from the library, and when, to retrieve an advertisement from the advertisement providing computing device 242 for presentation to the end user. As another non-limiting example, in some embodiments the functionality described herein as being provided by the tracking SDK 208 and/or the ad provider SDK 209 may not be included in a library file that is included in the application project used to create the associated application, but is instead accessed by virtue of the application performing remote function calls to an application programming interface (API) provided by the tracking system 120, the advertisement providing computing device 242, or some other element of the ecosystem 100.

In some embodiments, elements of the geolocation engine 212 are provided by an operating system and hardware included with the end user computing device 162A. For example, an end user computing device 162 such as a smartphone may include hardware that can be used to determine a global position, such as a global positioning system (GPS) sensor, an acceleration sensor, a magnetometer, a gyroscope, and/or any other suitable sensor. A smartphone may also include hardware that can be used to detect and analyze signals from wireless telephony towers in order to determine a location of the smartphone. Some end user computing devices 162 may also include wireless communication technology that may communicate with an indoor positioning system using WiFi, Bluetooth Low Energy, and/or any other suitable technology to determine a position of the end user computing device 162 with respect to a computing device of a known location. Components of the operating system of the end user computing device 162 may consume the signals from these sensors to determine the position of the end user computing device 162, and may provide the geolocation engine 212 to allow applications to access the determined position information.

In some embodiments, the customer computing device 132A and the advertisement providing computing device 242 create and distribute the advertisement to be tracked. The customer computing device 132A is operated by a customer having a product or service to advertise, and for which the customer wishes to track conversions based on the end user visiting a physical location. Accordingly, the customer uses the management interface to generate an impression link 202 and a click tracking link 203. The customer then combines the impression link 202, the click tracking link 203, and a geofence definition 206 with an advertisement 204, and provides the combination to the advertisement providing computing device 242 for distribution to end user computing devices 162. The advertisement providing computing device 242 could be an ad network computing device 142, an ad publisher computing device 152, or any other suitable computing device in the ecosystem 100 that distributes advertising to end users 160. Further details of the process of creating advertisements and tracking their effectiveness are provided below.

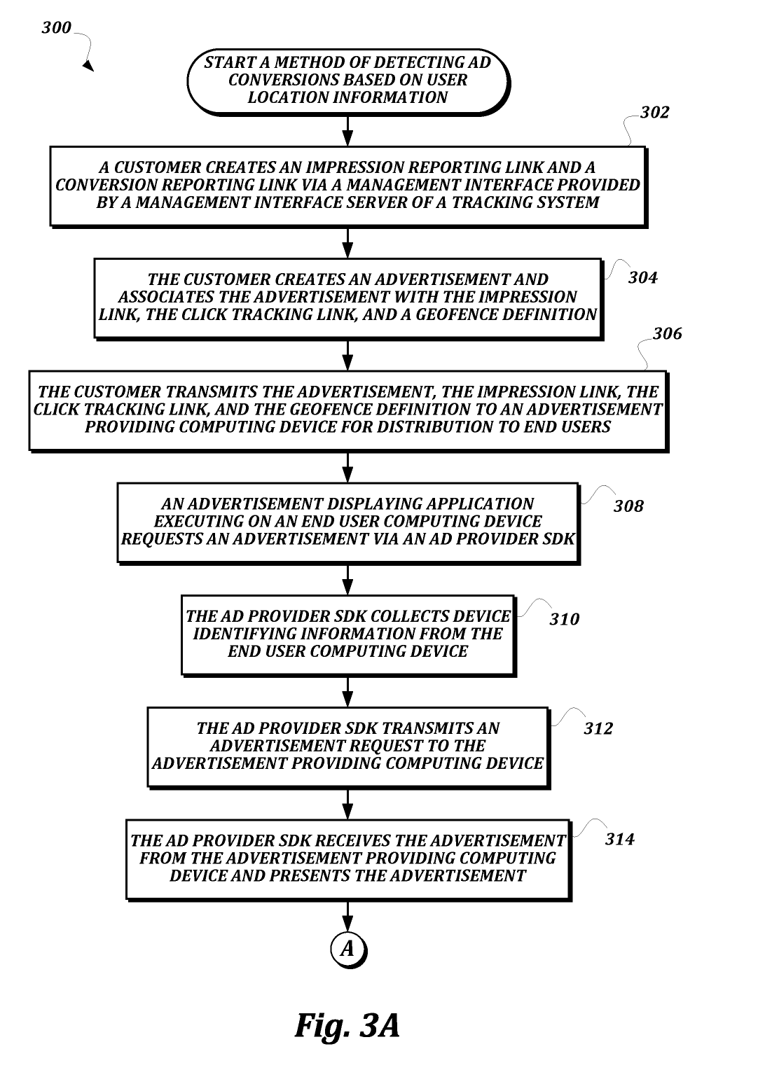

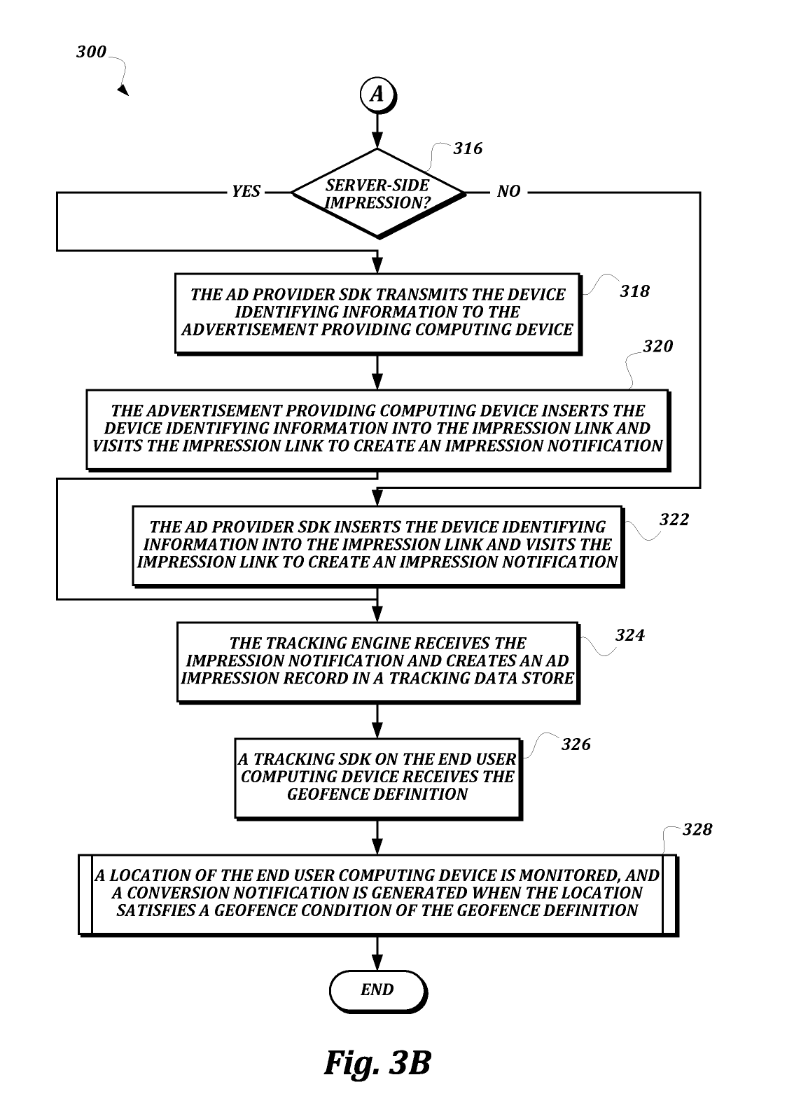

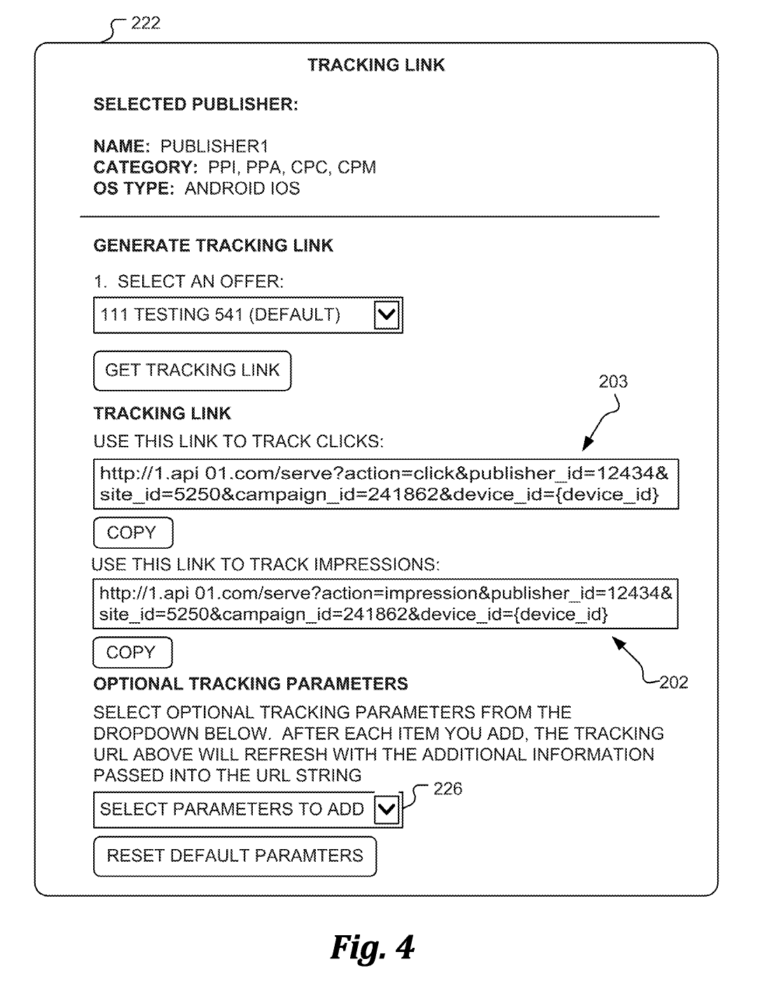

FIGS. 3A-3B are a flowchart that illustrates an exemplary embodiment of a method 300 of detecting ad conversions based on user location information according to various aspects of the present disclosure. From a start block, the method 300 proceeds to block 302, where a customer creates an impression link 202 and a click tracking link 203 via a management interface 123 provided by a management interface server 122C of a tracking system 120. FIG. 4 illustrates an exemplary embodiment of a tracking link page generated by the management interface engine 123 according to various aspects of the present disclosure. The customer may enter information and request the impression link 202. The example impression link 202 shown is:

“http://1.api-01.com/serve?action=impression&publisher_id=1243
4&
site_id=5250&campaign_id=241862&device_id={device_id}”

In this link, the destination address is “http://1.api-01.com/serve”, which identifies a location at the tracking server 122A. The publisher ID is set equal to the value “12434,” which identifies the advertisement provider (e.g., the Mobile Advertising Publisher 150 that operates the advertisement providing computing device 242). The site ID is set equal to the value “5250,” which identifies the application 201. The campaign ID is set equal to the value “241862,” which identifies the advertising campaign created by the customer. Thus, the information stored in the impression link 202 associates the advertisement with the advertisement provider, the application 214, and the advertising campaign. The device_id field is provided as a “macro,” which allows device identifying information to be inserted into the link once it is known in order to pass the device identifying information to the destination address.

The customer may include additional information in the impression link 202 by using a user input 226 (e.g., a dropdown box) to select additional parameters. When a parameter is selected using the user input 226, the impression link 202 is automatically modified to include the parameter and, if appropriate, a value assigned to the parameter. One of ordinary skill in the art will recognize that the illustrated click tracking link 203 may be generated in a similar manner and includes similar parameters. Once generated, the customer may copy the link to a clipboard or otherwise provide the link to a utility or other application used to assemble the advertisement information for submission to the advertisement providing computing device 242.

Returning to FIG. 3A, at block 304 the customer creates an advertisement 204 and associates the advertisement with the impression link 202, the click tracking link 203, and a geofence definition. The advertisement may include any form of media suitable for presentation via the end user computing device 162A, including but not limited to text, video, audio, static graphics, animated graphics, or a combination thereof. The geofence definition includes a specification of a geographical area and a geofence condition. In some embodiments, the geofence definition may also include information such as a site ID, a publisher ID, and/or a campaign ID as described above.

In some embodiments, the specification of a geographical area is in relation to a globally determined position of the end user computing device 162A. In such embodiments, the specification of the geographical area may include any suitable indication, including but not limited to a latitude and a longitude of a geographical point along with a radius that specifies a distance from the geographical point, a set of geographical points that define a polygonal geographical area, and/or the like. In some embodiments, the geographical area may include indications of more than one noncontiguous area. For example, the geographical area may include points and radii centered around multiple store locations, any of which may be suitable for generating a conversion.

In some embodiments, the specification of a geographical area is in relation to proximity to a specified computing device at a known location. In such embodiments, the specification of the geographical area may include identifiers of one or more computing devices to be detected, and may also include a minimum distance or radius from one or more of the specified computing devices.

The geofence condition may include logic for determining when the geofence is deemed to be crossed or entered. As one nonlimiting example, the geofence condition may state that any entry into the geographical area should be considered crossing the geofence. As another nonlimiting example, the geofence condition may state that an entry into the geographical area only counts if present within the geographical area for at least a specified amount of time. As yet another nonlimiting example, the geofence condition may state that an entry and an exit of the geographical area must be detected before the condition is considered satisfied. As still another nonlimiting example, the geofence condition may specify a maximum accuracy at which the determined location must be obtained for the location to be considered valid (e.g., a location accurate to 10 meters or less, as opposed to a location accurate to 100 meters).

In some embodiments, the geofence definition may be created by the customer using the management interface, and may be included in the click tracking link 203 or the impression link 202 generated by the management interface. In some embodiments, the geofence definition may be created by the customer using a separate tool or interface.

The method 300 then proceeds to block 306, where the customer transmits the advertisement, the impression link 202, the click tracking link 203, and the geofence definition 206 to an advertisement providing computing device 242 for distribution to end users. At block 308, an advertisement displaying application 164 executing on an end user computing device 162A requests an advertisement via an ad provider SDK 209. The method 300 then proceeds to block 310, where the ad provider SDK 209 collects device identifying information from the end user computing device 162A.

At block 312, the ad provider SDK 209 transmits an advertisement request to the advertisement providing computing device 242, and at block 314, the ad provider SDK 209 receives the advertisement 204 from the advertisement providing computing device 242 and presents the advertisement 204. Presenting the advertisement 204 may include any suitable form of media presentation, including displaying text, displaying an image, playing a sound clip, playing a video, and/or the like. When receiving the advertisement, the ad provider SDK 209 may also receive at least some of the information associated with the advertisement, such as the impression link 202, the click tracking link 203, and/or the geofence definition 206.

The method 300 then proceeds to a continuation terminal (“terminal A”). From terminal A (FIG. 3B), the method 300 proceeds to a decision block, where the flow of the method 300 branches based on whether impressions are to be tracked on the server-side or the client-side. When impressions are tracked on the server-side, the advertisement providing computing device 242 reports the impression to the tracking system 120. When impressions are tracked on the client-side, the end user computing device 162A notifies the tracking system 120 that the impression has occurred. Each technique has advantages. For example, if an impression is tracked on the client-side, then the device identifying information can be transmitted directly from the end user computing device 162A to the tracking system 120, thus providing greater protection of the privacy of the end user computing device 162A from the advertisement providing computing device 242. As another example, if an impression is tracked on the server-side, then the end user computing device 162A does not need to connect to the tracking system 120 at the time the advertisement 204 is presented, which can help improve performance and user experience.

If impressions are to be tracked on the server-side, then the YES branch at decision block 316 is followed, and the method 300 proceeds to block 318, where the ad provider SDK 209 transmits the device identifying information to the advertisement providing computing device 242. Next, at block 320, the advertisement providing computing device 242 inserts the device identifying information into the impression link 202 and visits the impression link 202 to create an impression notification. One of ordinary skill in the art will recognize that visiting the impression link causes the information inserted into the impression link 202 to be transmitted to the link destination (i.e., the tracking system 120). The method 300 then proceeds to block 324. If impressions are to be tracked on the client-side, then the NO branch at decision block 316 is followed, and the method 300 proceeds to block 322, where the ad provider SDK 209 inserts the device identifying information into the impression link 202 and visits the impression link 202 to create an impression notification. The method 300 then proceeds to block 324.

Regardless of how the impression notification was created, at block 324, the tracking engine 124 receives the impression notification and creates an ad impression record 126 in a tracking data store 125. The ad impression record 126 includes relevant information describing the ad impression, such as the device identifying information, the publisher identifier, the offer identifier, a timestamp, and/or the like.

Next, at block 326, a tracking SDK 208 on the end user computing device 162A receives the geofence definition. The method 300 then proceeds to procedure block 328, where a procedure is executed wherein a location of the end user computing device 162A is monitored, and a conversion notification is generated when the location satisfies a geofence condition of the geofence definition. Various different procedures may be utilized at procedure block 328 to monitor the location and visit the conversion link 202, several examples of which are described in detail below. The method 300 then proceeds to an end block and terminates.

While the embodiment of the method 300 described above begins monitoring a geofence upon detection of an ad impression, in some embodiments the geofence may not be monitored until a click on the advertisement is detected. In such an embodiment, the click tracking link 203 may be followed instead of or in addition to the impression link 202, and an ad click record 213 may be created instead of or in addition to the impression record 126.

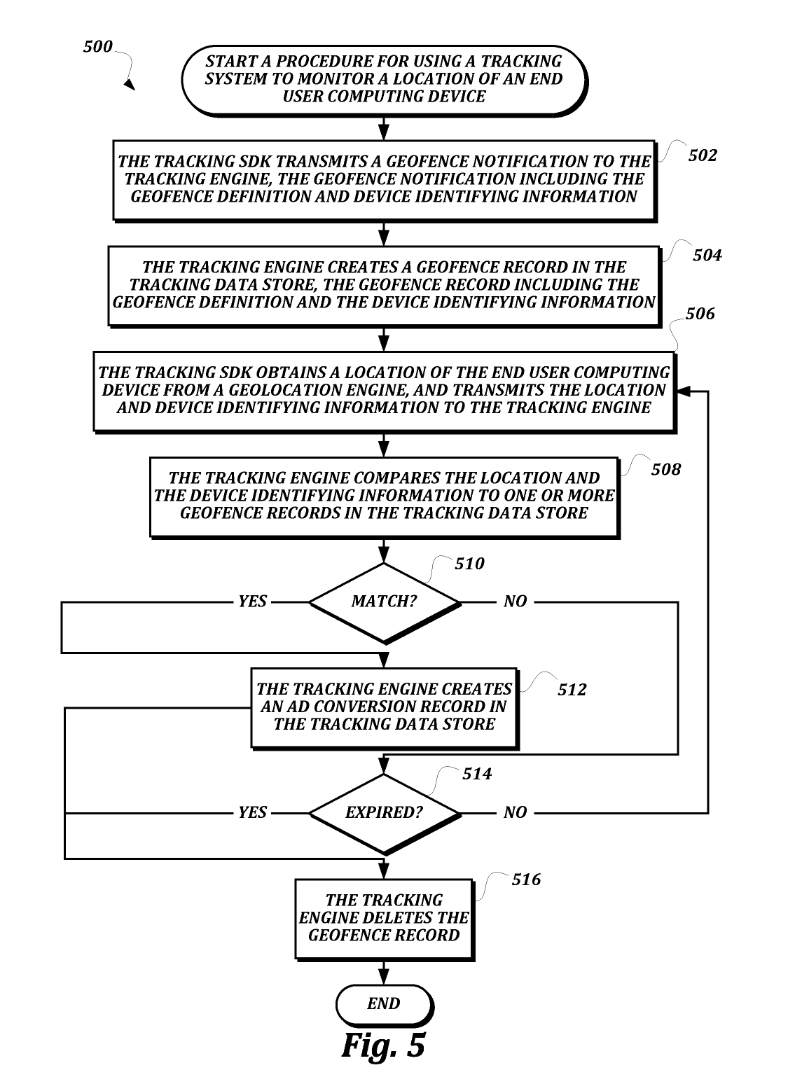

FIG. 5 is a flowchart that illustrates an exemplary embodiment of a procedure 500 for using a tracking system 120 to monitor a location of an end user computing device 162A according to various aspects of the present disclosure. One of ordinary skill in the art will recognize that the procedure 500 is suitable for use as the procedure referred to in procedure block 328 of FIG. 3B. In the procedure 500, the location of the end user computing device 162A is monitored by the tracking system 120. This may be desirable for any one of several reasons. For example, the operator of the tracking system 120 may wish to collect and record location information about end users for future analysis of consumer behavior. As another example, offloading the location processing to the tracking system 120 may reduce the computing resources used on the end user computing device 162A by the method 300, and may therefore improve the end user experience or allow the method 300 to work on less-powerful computing devices.

From a start block, the procedure 500 advances to block 502, where the tracking SDK 208 transmits a geofence notification to the tracking engine 124, the geofence notification including the geofence definition 206 and device identifying information. Next, at block 504, the tracking engine 124 creates a geofence record 210 in the tracking data store 125, the geofence record 210 including the geofence definition 206 and the device identifying information.

The procedure 500 proceeds to block 506, where the tracking SDK 208 obtains a location of the end user computing device 162A from a geolocation engine 212, and transmits the location and device identifying information to the tracking engine 124. The location transmitted to the tracking engine 124 may be any type of location information produced by the geolocation engine 212, such as a combination of a longitude, a latitude, and an accuracy; a device identifier of a detected computing device of an indoor positioning system and a distance from the detected computing device, and/or the like. Next, at block 508, the tracking engine 124 compares the location and the device identifying information to one or more geofence records 210 in the tracking data store 125. In some embodiments, instead of comparing the location and device identifying information to the geofence records 210 upon receipt, the tracking engine 124 may instead store the received information in a user location record 216, and may later compare the information in the user location records 216 to the geofence records 210.

At decision block 510, a test is performed to determine whether any of the geofence records 210 match the location and device identifying information. If there is a match between the device identifying information and the location received by the tracking engine with the location defined in the geofence definition 206 of a geofence record 210, and if the geofence condition included in the geofence definition 206 of the geofence record 210 is satisfied, then the result of the test at decision block 510 is YES, and the procedure 500 proceeds to block 512, where the tracking engine 124 creates an ad conversion record 214 in the tracking data store 125. The procedure 500 then proceeds to block 516.

Otherwise, if there was no match between the location and the device identifying information with a geofence record 210, the procedure 500 proceeds to decision block 514, where a test is performed to determine whether the geofence record that was added at block 504 has expired. In some embodiments, the geofence record may include an expiration date or time so that resources are not wasted by monitoring the location of the end user computing device 162A in perpetuity, particularly since as time passes, it becomes less likely that the advertisement presented to the end user was responsible in a meaningful way for the action taken by the end user. In some embodiments, the expiration date or time may be far in the future, or may not be specified at all (so that the geofence is monitored in perpetuity in order to record multiple conversions). If the determination at decision block 514 is that the geofence record has expired, then the result of the test at decision block 514 is YES, and the procedure 500 proceeds to block 516. Otherwise, if the geofence record has not expired, then the result of the test at decision block 514 is NO, and the procedure 500 returns to block 506 for further monitoring of the location of the end user computing device 162A.

At block 516, the tracking engine 124 deletes the geofence record 210 from the tracking data store 125. The procedure 500 then advances to an end block and terminates.

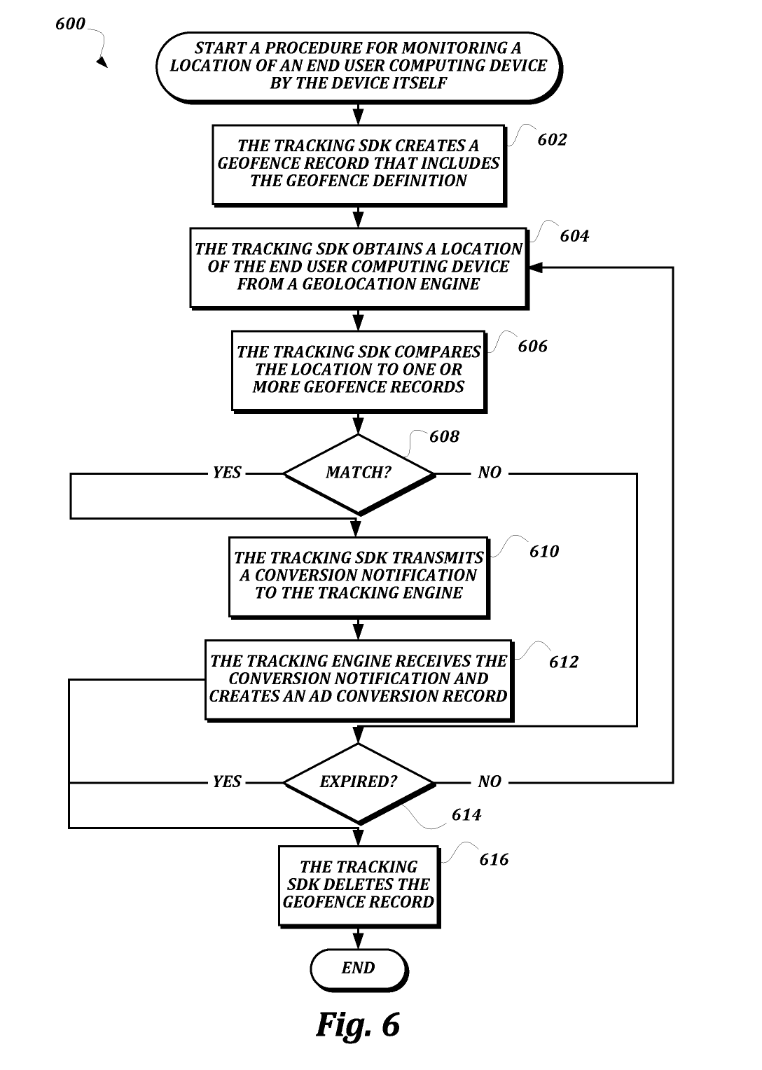

FIG. 6 is a flowchart that illustrates an exemplary embodiment of a procedure 600 for monitoring a location of an end user computing device 162A by the device itself, according to various aspects of the present disclosure. One of ordinary skill in the art will recognize that the procedure 600 is suitable for use as the procedure referred to in procedure block 328 of FIG. 3B. In the procedure 600, the location of the end user computing device 162A is monitored by the tracking SDK 208 on the end user computing device 162A itself. This may be desirable for any one of several reasons. For example, comparing the location of the end user computing device 162A to the geofence records 210 on the end user computing device 162A allows the tracking functionality to be provided without having to report detailed location information to the tracking system 120. This can help to protect the privacy of the end user. As another example, performing the comparisons on the end user computing device 162A reduces the amount of network traffic generated by the method 300, because the location information can be processed locally instead of being transmitted over the network 180 for processing.

From a start block, the procedure 600 advances to block 602, where the tracking SDK 208 creates a geofence record 210 that includes the geofence definition 206. In some embodiments, the geofence record 210 may be stored by the geolocation engine 212 as illustrated in FIG. 2, or may be stored in another data store local to or otherwise accessible by the end user computing device 162A. The contents of the geofence record are similar to the contents of the geofence record described above, though the geofence record 210 stored by the end user computing device 162A may omit the device identifying information because all of the geofence records stored in the same location may refer to the single end user computing device 162A.

Next, at block 604, the tracking SDK 208 obtains a location of the end user computing device 162A from a geolocation engine 212. Similar to the discussion above, the obtained location may be a combination of a longitude, a latitude, and an accuracy; a device identifier of a detected computing device of an indoor positioning system and a distance from the detected computing device, and/or any other suitable form of location information. At block 606, the tracking SDK 208 compares the location to locations defined in the geofence definitions 206 of one or more geofence records 210, and at decision block 608, a test is performed to determine whether any of the geofence records 210 stored on the end user computing device 162A match the location information. In some embodiments, the end user computing device 162A may store location trail information, and instead of processing an obtained location soon after it is determined, the tracking SDK 208 may analyze the location trail information instead of a single location obtained from the geolocation engine 212.

If there is a match between the location obtained by the tracking SDK 208 and a geofence definition 206 in a geofence record 210, and if the geofence condition included in the geofence record 210 is satisfied, then the result of the test at decision block 608 is YES, and the procedure 600 proceeds to block 610, where the tracking SDK 208 transmits a conversion notification to the tracking engine 124. In some embodiments, the tracking SDK 208 is preconfigured to transmit the conversion notification to a location served by the tracking server 122A. Accordingly, at block 612, the tracking engine 124 receives the conversion notification and creates an ad conversion record 214. In some embodiments, the conversion notification includes the device identifying information, the offer identifier, the publisher identifier, and/or the like. The ad conversion record 214 created by the tracking engine 124 may include some or all of this information as well. The procedure 600 then advances to block 616.

If there is not a match between the location obtained by the tracking SDK 208 and one of the geofence records 210, then the result of the test at decision block 608 is NO, and the procedure 600 advances to decision block 614, where a test is performed to determine whether the geofence record that was added at block 602 has expired. Similar to the discussion above, the geofence record 210 stored by the end user computing device 162A may include an expiration time so that the location is not monitored with respect to the record in perpetuity, or it may not. If the determination at decision block 614 is that the geofence record 210 has expired, then the result of the test at decision block 614 is YES, and the procedure proceeds to block 616. Otherwise, if the geofence record has not expired, then the result of the test at decision block 614 is NO, and the procedure 600 returns to block 604 for further monitoring of the location of the end user computing device 162A.

At block 616, the tracking SDK 208 deletes the geofence record 210 (either the expired geofence record 210 or the matching geofence record 210 for which a conversion was recorded) from the end user computing device 162A. The procedure 600 then advances to an end block and terminates.

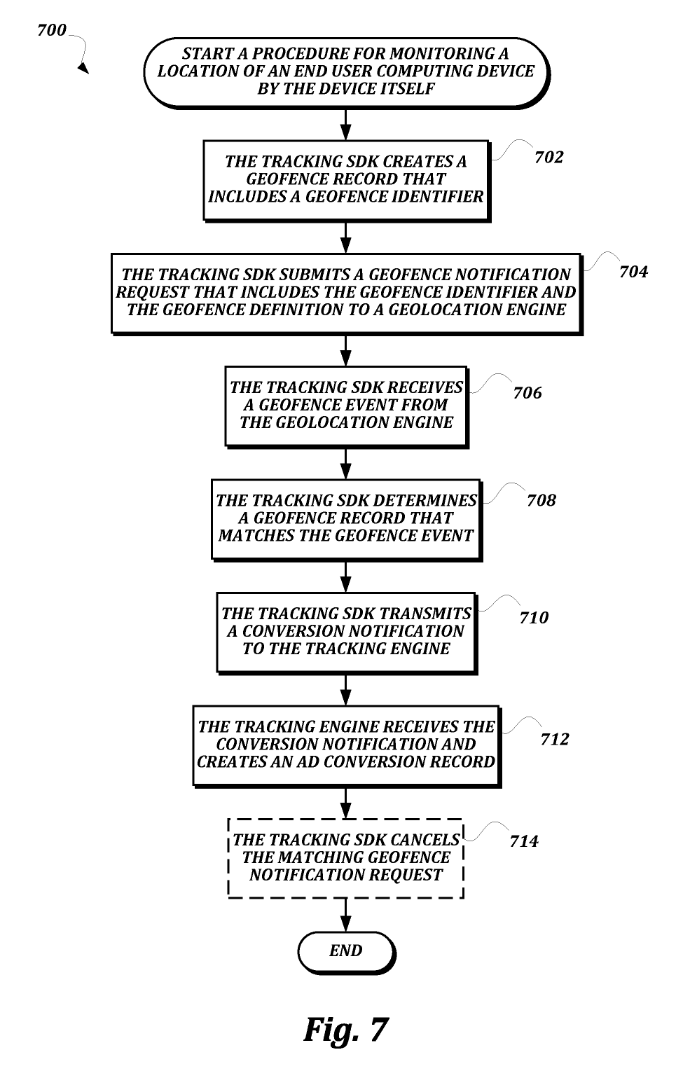

FIG. 7 is a flowchart that illustrates another exemplary embodiment of a procedure 700 for monitoring a location of an end user computing device 162A by the device itself, according to various aspects of the present disclosure. One of ordinary skill in the art will recognize that the procedure 700 is suitable for use as the procedure referred to in procedure block 328 of FIG. 3B. In the procedure 700, the location of the end user computing device 162A is monitored by components native to the operating system of the end user computing device 162A, and the tracking SDK 208 is notified when appropriate. This may be desirable for any one of several reasons. For example, as with the procedure 600 described above, monitoring the location using the operating system of the end user computing device 162A avoids transmitting detailed location information that is not relevant to a monitored geofence to the tracking system 120, thus protecting user privacy and reducing bandwidth requirements. As another example, using built-in capabilities of the operating system of the end user computing device 162A may be particularly efficient, compared to performing similar tasks in an application. As yet another example, location monitoring may be offered by the operating system of the computing device 162A in the background on a constant basis, whereas the tracking SDK 208 may only be available to monitor location with respect to the geofence records 210 when an application 201 that includes the tracking SDK 208 is actively executing on the end user computing device 162A.

From a start block, the procedure 700 advances to block 702, where the tracking SDK 208 creates a geofence record 210 that includes a geofence identifier. The geofence identifier uniquely identifies the established geofence, and in some embodiments, the geofence record 210 may include additional information such as the geofence definition 206, a site ID, a publisher ID, and/or the like. Next, at block 704, the tracking SDK 208 submits a geofence notification request that includes the geofence identifier and the geofence definition to a geolocation engine 212. In some embodiments, only a part of the geofence definition, such as the geographical area to be monitored or an identifier of a computing device to be detected, may be submitted to the geolocation engine 212. In some embodiments, the geofence condition may also be submitted to and monitored by the geolocation engine 212.

At block 706, the tracking SDK 208 receives a geofence event from the geolocation engine 212. The geolocation engine 212 may submit the event to the tracking SDK 208 via a callback or any other suitable mechanism. The geofence event may include the geofence identifier in order to notify the tracking SDK 208 which geofence record 210 caused the event to fire. In some embodiments, the geofence event may include the location information and not the geofence identifier, and the tracking SDK 208 may use the location information to determine the geofence record 210 associated with the event. In some embodiments, the geolocation engine 212 may wake up or load the application 201 in order to provide the event to the tracking SDK 208. In some embodiments, the geolocation engine 212 may wait to provide the event to the tracking SDK 208 until the application 201 is loaded and the tracking SDK 208 proactively requests the event, instead of waking up or loading the application 201.

At block 708, the tracking SDK 208 determines a geofence record 210 that matches the geofence event, using either the geofence identifier or the location information included in the geofence event. In some embodiments wherein the geolocation engine 212 does not process the geofence condition, the tracking SDK 208 may also evaluate the geofence condition to determine if a geo fence record 210 matches the geofence event. If no matching geofence record is found, the procedure 700 may return to block 706 to await a subsequent event. Next, at block 710, the tracking SDK 208 transmits a conversion notification to the tracking engine 124.

At block 712, the tracking engine 124 receives the conversion notification and creates an ad conversion record 214. As discussed above, the conversion notification may include information such as the device identifying information, the offer identifier, the publisher identifier, and/or the like. The ad conversion record 214 created by the tracking engine 124 may include some or all of this information as well. At optional block 714, the tracking SDK 208 cancels the matching geofence notification request 714 with the geolocation engine 212 (if desired), and then the procedure 700 advances to an end block and terminates.

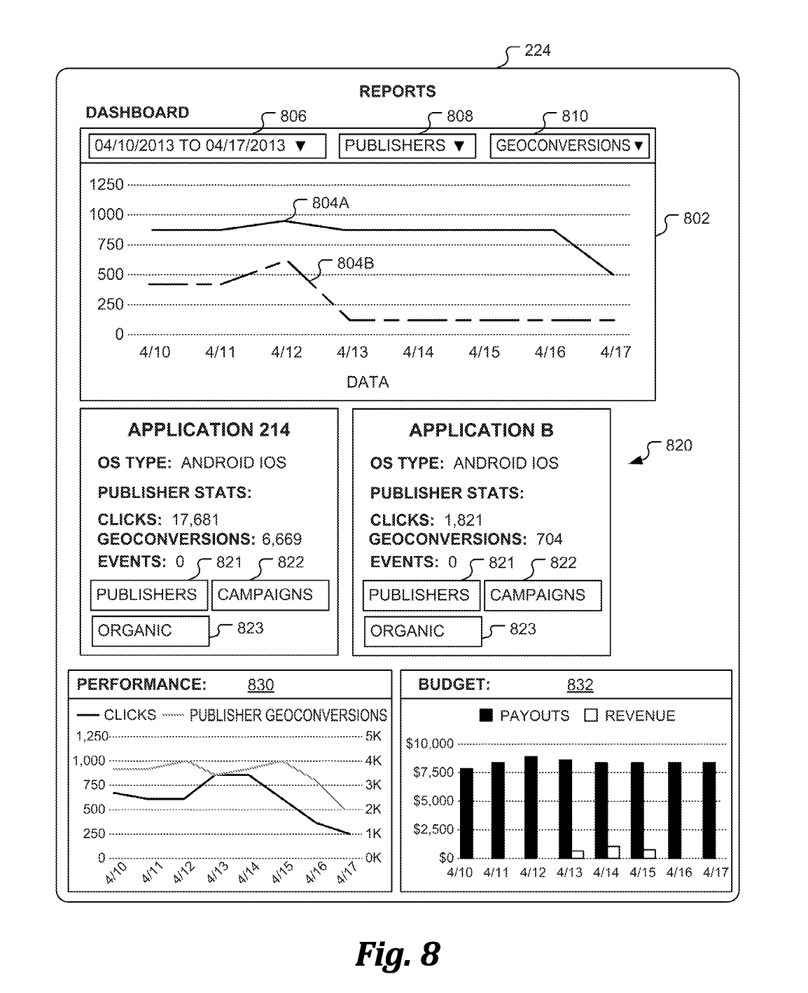

Once ad impression records 126 and ad conversion records 214 are stored in the tracking data store 125, the tracking system 120 may use these records to attribute conversions to one or more ad providers and to provide appropriate credit to the attributed ad providers. FIG. 8 is an illustration of an exemplary reports page 224 generated by the management interface engine 123 that may be used to analyze advertising performance and to display credits provided to attributed ad providers according to various aspects of the present disclosure. The reports page 224 includes a graph 802. Each line (e.g., lines 804A and 804B) on the graph 802 depicts data for a selected application tracked by the tracking system 120. For ease of illustration, in FIG. 8, the graph 802 includes the line 804A, which depicts data for a first application, and the line 804B, which depicts data for a second application marketed by the same customer as the first application. Thus, on the graph 802, multiple lines may be used to depict data for multiple applications.

The x-axis is a predetermined date range. A user input 806 may be used to specify the predetermined date range. The y-axis is a number of events tracked by the tracking system. A user input 810 may be used to select the type of event. For example, the user input 810 as illustrated has selected “installs,” but the user input 810 may instead select impressions, conversions, geofence conversions, and/or the like.

A user input 808 may be used to select “publishers,” “organics,” or “totals.” If “publishers” is selected, only events attributable to an advertising provider will be included in the graph 802. If “organics” is selected, only events not attributable to an advertising provider will be included in the graph 802. If “totals” is selected, all events will be included in the graph 802.

In FIG. 8, “publishers” has been selected in the user input 808, and “geoconversions” has been selected in the user input 810. Thus, the line 804A depicts a number of geoconversions that occurred associated with advertising for the application 214 from April 10 to April 17 that were attributed to one of the advertising providers. The graph 802 may be used to evaluate the overall effectiveness of an advertising campaign.

The reports page 224 includes an area 820 in which information about each of the applications marketed by the customer may be displayed. In this example, buttons or links are associated with each application. The customer may select the buttons or links to view more information about each application. In FIG. 8, the buttons include a publishers button 821, a campaigns button 822, and an organic button 823. When one of these buttons is clicked, a new table or graph (not shown) may be displayed that may help the customer evaluate (1) the effectiveness of particular publishers with respect to getting users to take the action encouraged by an advertising campaign, (2) the effectiveness of particular campaigns, and/or (3) the number of actions that occur organically.

The reports page 224 includes a performance graph 830 and a budget graph 832. The graphs 830 and 832 may be used to show total customer numbers for all of the customer's marketed products and/or services. For example, the performance graph 830 may be used to depict a total number of clicks and conversions the customer is experiencing for all of its applications over the predetermined date range. The budget graph 832 may be used to depict a payout amount and an amount of revenue generated by all of the customer's applications over the predetermined date range. The graphs 830 and 832 may help provide an overview of how well the customer is doing overall.

Access to reporting information may not be limited to advertisers 130. In some embodiments, advertising publishers 150 and/or advertising networks 140 may be provided access to reporting data as well. In some embodiments, advertising publishers 150 may be provided access to a subset of the tracking information and metrics in order to allow the advertising publishers 150 to analyze their performance without disclosing sensitive information. For example, in some embodiments, advertising publishers 150 may be provided access to logs of conversions for which they have been provided credit, but they may be prevented from accessing logs of actual conversions and may instead only be given access to aggregated performance counts. Further, information that falls outside of the publisher's attribution window may be hidden from the publisher, even if it is collected and made available to advertisers 130. For example, non-windowed install contributions may be hidden from advertising publishers 150 to prevent advertising publishers 150 from using the information to change their billing models to maximize total potential conversions (e.g., by altering their attribution window policies).

### Computing Device

FIG. 9 is a diagram of hardware and an operating environment in conjunction with which implementations of the one or more computing devices of the ecosystem 100 may be practiced. The description of FIG. 9 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, smartphones, network-connected tablet computers, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 9 includes a general-purpose computing device in the form of the computing device 12. Each of the computing devices of FIG. 1 (including the computing devices 122, 132, 142, 152, 162, and 172) may be substantially similar or identical to the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those skilled in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feed back game controller).

The input devices described above are operable to receive user input and selections. Together the input and display devices may be described as providing a user interface. The user interface is configured to display portions of the management interface 123 to appropriate users.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 9 include a local-area network (LAN) 51 and a wide-area network (WAN) 52. Such networking environments are commonplace in offices, enterprise-wide computer networks, intranets and the Internet. The network 180 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the method 300 illustrated in FIGS. 3A-3B) described above. Such instructions may be stored on one or more non-transitory computer-readable media.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Accordingly, the invention is not limited except as by the appended claims.

The embodiments of the invention in which an exclusive property or privilege is claimed are defined as follows:

1. A computer-implemented method for determining advertising effectiveness, the method comprising:
generating, by an end user computing device, an impression for an advertisement presented to an end user;
monitoring, by the end user computing device, a location of the end user computing device; and
generating, by the end user computing device, a conversion for the advertisement in response to determining that a geofence condition associated with the advertisement has been satisfied based on the monitored location of the end user computing device.

2. The method of claim 1, wherein the geofence condition includes being present within a specified geographical area for at least a specified amount of time.

3. The method of claim 1, wherein the geofence condition includes being located proximate to a computing device of an indoor positioning system for at least a specified amount of time.

4. The method of claim 1, wherein monitoring a location includes:
obtaining, by a tracking software development kit (SDK) executing on the end user computing device, position information from a geolocation engine of the end user computing device; and
comparing, by the tracking SDK, the position information to geofence definitions in one or more geofence records.

5. The method of claim 1, wherein monitoring a location includes registering a geographical area to be monitored with an operating system of the end user computing device.

6. The method of claim 1, wherein monitoring a location includes:
obtaining, by a tracking software development kit (SDK) executing on the end user computing device, position information from a geolocation engine of the end user computing device; and
transmitting, by the tracking SDK, the position information to a tracking system to be compared to geofence definitions in one or more geofence records.

7. The method of claim 1, wherein generating a conversion includes:
inserting, by the end user computing device, device identifying information into a conversion notification associated with the advertisement; and
transmitting, by the end user computing device, the conversion notification to a tracking system.

8. A system for determining advertising effectiveness, the system comprising:
a tracking data store configured to store a set of advertising impression records and a set of advertising conversion records; and
a tracking engine configured to:
create an advertising impression record in the tracking data store in response to receiving an impression notification that indicates that an advertisement was presented to an end user; and
create an advertising conversion record in the tracking data store in response to receiving a conversion notification that indicates that a location of an end user computing device associated with the end user satisfied a geofence condition associated with the advertisement.

9. The system of claim 8, wherein the tracking data store is further configured to store a set of geofence records; and wherein the tracking engine is further configured to:
receive a geofence notification that includes a geofence definition; and
create a geofence record that includes the geofence definition in the tracking data store.

10. The system of claim 9, wherein the tracking engine is further configured to:
receive location information from the end user computing device; and
compare the location information to geofence definitions in the set of geofence records stored by the tracking data store.

11. The system of claim 10, wherein the tracking engine is further configured to:
in response to determining that the location information matches a geofence definition in a given geofence record stored by the tracking data store, generating a conversion notification.

12. The system of claim 11, wherein determining that the location information matches a geofence definition includes determining that the location information indicates that the end user computing device was present within a specified geographical area for at least a specified amount of time.

13. The system of claim 8, further comprising a management interface server configured to provide a management interface that includes functionality for generating click tracking links and impression links.

14. The system of claim 8, wherein the tracking engine is further configured to provide credit to an advertisement provider associated with the advertisement based on the advertisement conversion record.

15. A nontransitory computer-readable medium having computer-executable instructions stored thereon that, in response to execution by one or more processors of an end user computing device, cause the end user computing device to perform actions for determining advertising effectiveness, the actions comprising:
generating, by the end user computing device, an impression for an advertisement presented to an end user;
monitoring, by the end user computing device, a location of the end user computing device; and
generating, by the end user computing device, a conversion for the advertisement in response to determining that a geofence condition associated with the advertisement has been satisfied based on the monitored location of the end user computing device.

16. The computer-readable medium of claim 15, wherein the geofence condition includes being present within a specified geographical area for at least a specified amount of time.

17. The computer-readable medium of claim 15, wherein the geofence condition includes being located proximate to a computing device of an indoor positioning system for at least a specified amount of time.

18. The computer-readable medium of claim 15, wherein monitoring a location includes:
obtaining position information from a geolocation engine of the end user computing device; and
comparing the position information to geofence definitions in one or more geofence records.

19. The computer-readable medium of claim 15, wherein monitoring a location includes registering a geographical region to be monitored with an operating system of the end user computing device.

20. The computer-readable medium of claim 15, wherein monitoring a location includes:
obtaining position information from a geolocation engine of the end user computing device; and
transmitting the position information to a tracking system to be compared to geofence definitions in one or more geofence records.

21. The computer-readable medium of claim 15, wherein generating a conversion includes:
inserting, by the end user computing device, device identifying information into a conversion link associated with the advertisement; and
visiting, by the end user computing device, the conversion link.
